(19) United States
(12) Patent Application Publication
(10) Pub. No.: US 2003/0177756 A1
(43) Pub. Date: Sep. 25, 2003

(54) Apparatus and method for positron fueled ramjet operation

(76) Inventors: Kirby J. Meyer, Santa Fe, NM (US); John D. Metzger, Northport, NY (US); Gerald A. Smith, Scottsdale, AZ (US)

Correspondence Address: SAMUEL W. APICELLI, DUANE MORRIS LLP, 305 NORTH FRONT STREET, P.O. BOX 1003, HARRISBURG, PA, 17108-1003, US

(21) Appl. No.: 10/102,398

(22) Filed: Mar. 20, 2002

(51) Int. Cl. F02K 11/00

(52) U.S. Cl. 60/203.1; 60/204

(57) ABSTRACT

An apparatus and method for positron fueled ramjet operation is provided including a convection chamber for a ramjet comprising a rate of absorption of gamma rays that yields a uniform heating of the convection chamber to a temperature sufficient to sustain ramjet operation. The convection chamber may comprise at least one open ended cylinder, a plurality of concentrically arranged cylinders, a plurality of rods, a honeycomb structure or other structures for absorbing gamma rays. A ramjet powered by gamma rays is also provided that includes a housing forming a fluid passageway. A reaction vessel is positioned within the housing, and arranged in flow communication with a source of positrons. A gamma ray absorption assembly is positioned within the fluid passageway so that as positrons interact with electrons and annihilate, gamma rays impinge upon the gamma ray absorption assembly. A method of heating a convection chamber of a ramjet engine is also provided in which a plurality of positrons are annihilated by interaction with an equal plurality of electrons at a controlled rate of annihilation so as to produce a steady emission of gamma rays. The gamma rays are absorbed by a convection chamber of the ramjet engine wherein the convection chamber comprises a rate of absorption of gamma rays that yields a uniform heating of the convection chamber to a temperature sufficient to sustain ramjet operation.

### FIELD OF THE INVENTION

The present invention generally relates to propulsion systems and, more particularly, to a ramjet propulsion system that utilizes positron annihilation as a fuel source.

### BACKGROUND OF THE INVENTION

Ramjet engines and their operation are well known in the art as a propulsion system for high speed flying vehicles, e.g., jet aircraft, missiles, rockets, etc. A ramjet engine generally operates by capturing and compressing an air stream impinging upon an inlet structure in the ramjet engine. The compressed air stream provides oxygen for mixing with a fuel, such as a suitable hydrocarbon, which is supplied to a combustion chamber located adjacent to the inlet structure in the interior of the ramjet engine. The fuel is oxidized in the combustion chamber so as to produce expanding combustion gases. The expanding combustion gases escape through a nozzle structure at supersonic velocities, and produce a forward thrust to the ramjet and the attached vehicle.

A unique aspect of ramjet engines is the fact that the rate of air compression depends upon the speed of flight of the vehicle, rather than on a mechanical compressor. The high-pressure air streaming into the combustion chamber acts to prevent the air fuel mixture from effectively reacting toward the air intake end of the engine. Ramjet engines will not function until a sufficient air stream is flowing through the intake to create a high-pressure flow. Without this high-pressure stream of air, the expanding gases of the oxidizing fuel-air mixture within the combustion chamber would be expelled from both ends of the engine. Thus there is a need with all ramjet propelled systems to accelerate the vehicle from 0 or low velocity to a velocity where the ramjet will begin to operate on its own (Mach number of about 0.5-1). Typically, a ramjet propelled vehicle must be boosted to a predetermined speed by some other type of engine or vehicle.

Conventional ramjets powered by the oxidation of chemical fuels have a limited utility. For example, a ramjet weighing about forty kilograms, and combusting about four to five kilograms of chemical fuel, may stay aloft at about a one thousand meter altitude for approximately one-half hour. This is sufficient time for such applications as rocket and missile boosters; however, it is far to short a time for use of such a device in unmanned surveillance and ordnance delivery systems, passenger aircraft, airborne weather data acquisition and recordation systems, and airborne telecommunications systems or sensor systems, such as, cellular telephone hubs, or environmental, agriculture, and the like monitors. Thus there is a need for a ramjet powered vehicle that is fueled in such a way that its total flight time is significantly extended, out to at least several days or weeks.

Propulsion systems using matter/antimatter annihilation have been postulated in the prior art as a substitute for chemical based fuel sources. For example, antiproton annihilation fueled engines have been proposed where the matter/antimatter annihilation yields at least ten orders of magnitude greater energy per unit density than stored chemical energy. However, antiproton-proton annihilation results in the emission of pi-mesons and gamma rays in excess of nuclear reaction thresholds. Anti-electrons (“positrons”) occur naturally as a by-product of radioactive decay, e.g., radioactive sodium emits positrons. Positrons are significantly less massive than an antiproton, so that their annihilation with electrons results in gamma ray emissions that are below nuclear reaction thresholds, making such annihilation acceptable for use in close proximity to humans, and in the atmosphere. Positrons may be gathered and stored in a variety of ways. Using simple energy density scaling, a ramjet powered by as little as one milligram of positrons may stay aloft at the same altitude for multiple hours, if not days.

It would be advantageous to have a ramjet engine that did not require conventional chemical fuels, but rather utilized matter/antimatter annihilation as a source of power.

### SUMMARY OF THE INVENTION

The present invention provides a structure that yields a heat transfer function that is directly analogous to a combustion chamber for a conventional ramjet, but has a structure that provides a rate of absorption of gamma rays that yields a uniform heating of that structure, defined throughout as a “convection chamber” to a temperature sufficient to sustain ramjet operation. In one embodiment, the convection chamber comprises at least one open ended cylinder or a plurality of concentrically arranged cylinders. In other embodiments, the convection chamber for a ramjet comprises a plurality of rods, a honeycomb structure or other means for absorbing gamma rays so as to yield a uniform heating of the absorbing means to a temperature sufficient to sustain ramjet operation.

A ramjet powered by gamma rays resulting from positron/electron annihilations is also provided that includes a housing having a first open end, a second open end, and defining an interior chamber in fluid communication with the first open end and the second open end so as to form a fluid passageway. A reaction vessel is positioned within the interior chamber of the ramjet, and arranged in flow communication with a source of positrons so as to provide a flow of positrons into the reaction vessel. A gamma ray absorption assembly is positioned within the fluid passageway and adjacent to the reaction vessel so that as positrons interact with electrons and annihilate, gamma rays radiate from the reaction vessel and impinge upon the gamma ray absorption assembly. The gamma ray absorption assembly provides a function within the ramjet of the present invention that is directly analogous to a combustion chamber. In particular, gamma ray absorption assembly is uniformly heated by the absorption of a plurality of gamma rays resulting from the continuous annihilation of positrons and electrons within the reaction vessel thereby heating it to a temperature sufficient to sustain ramjet operation.

A method of heating a convection chamber of a ramjet engine is also provided in which a plurality of positrons are urged into interaction with an equal plurality of electrons so as to annihilate one another at a controlled rate of annihilation thereby producing a steady emission of gamma rays. The gamma rays are absorbed by a convection chamber of the ramjet engine wherein the convection chamber comprises a rate of absorption of gamma rays that yields a uniform heating of the convection chamber to a temperature sufficient to sustain ramjet operation.

### BRIEF DESCRIPTION OF THE DRAWINGS

These and other features and advantages of the present invention will be more fully disclosed in, or rendered obvious by, the following detailed description of the preferred embodiments of the invention, which are to be considered together with the accompanying drawings wherein like numbers refer to like parts and further wherein:

FIG. 1 is a perspective view of an aircraft having a ramjet engine formed in accordance with the present invention;

FIG. 2 is a longitudinal cross-sectional view of a ramjet engine formed in accordance with the present invention;

FIG. 3 is a broken-away, cross-sectional view of a leading portion of the ramjet shown in FIG. 2;

FIG. 4 is a broken-away, cross-sectional view of a trailing portion of the ramjet shown in FIG. 2;

FIG. 5 is a cross-sectional view of the trailing end of the ramjet shown in FIG. 2, showing a concentric shell embodiment of a gamma ray absorption assembly formed in accordance with the present invention;

FIG. 6 is a cross-sectional view of the trailing end of the ramjet shown in FIG. 2, showing a plurality of rods arranged as a gamma ray absorption assembly formed in accordance with an alternative embodiment of the present invention;

FIG. 7 is a cross-sectional view of the trailing end of the ramjet shown in FIG. 2, showing a honeycomb construction arranged as a gamma ray absorption assembly formed in accordance with an alternative embodiment of the present invention; and

FIG. 8 is a cross-sectional view of the trailing end of the ramjet shown in FIG. 2, showing a mesh construction arranged as a gamma ray absorption assembly formed in accordance with an alternative embodiment of the present invention.

### DETAILED DESCRIPTION OF THE INVENTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom,” “leading” and “trailing,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

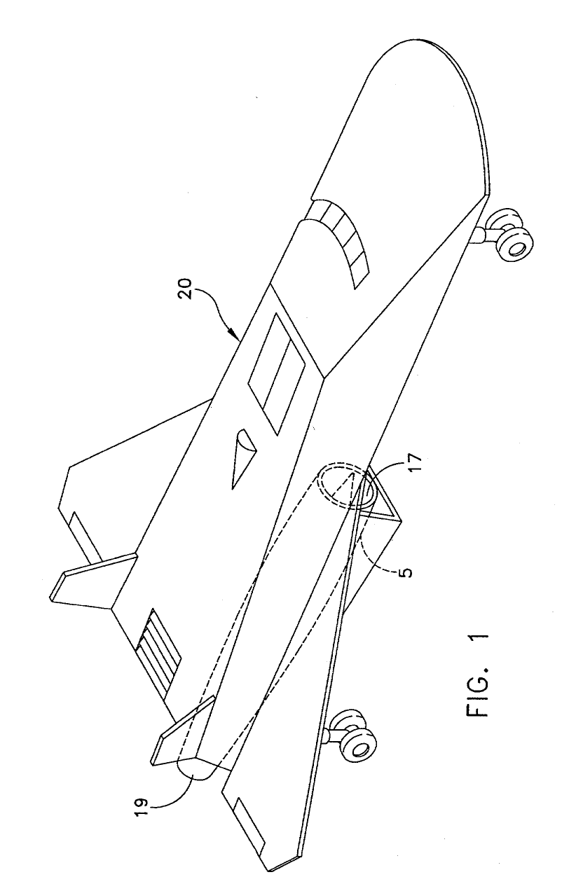

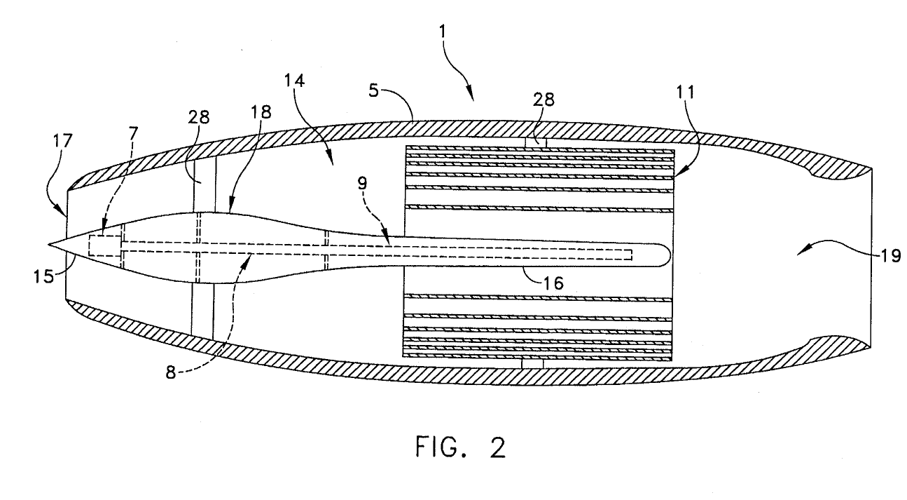

Referring to FIGS. 1 and 2, a ramjet 1 formed in accordance with one embodiment of the present invention comprises a housing 5, a positron source 7, a transfer conduit 8, a reaction vessel 9, and a gamma ray absorption assembly 11. Housing 5 is often formed as an open ended tube (typically a prolate spheroid) that defines an interior chamber 14 having a first open end 17 and a second open end 19. Other tubular shapes and profiles are also possible. It will be understood that conventional structural features may be fitted to the exterior and interior of housing 5 so as to allow for the mounting of ramjet 1 on or within a vehicle 20, e.g., an aircraft, a missile, a rocket, torpedo, or the like vehicle. The various known metals that are normally used in aircraft construction may be used to fabricate housing 5, e.g., aluminum, titanium, tungsten, and their alloys, as well as, carbon fiber composite materials.

Positron source 7, transfer conduit 8, and reaction vessel 9 are housed within a diffuser housing 18 of the type normally employed in conventional ramjets. The leading portion 15 of diffuser housing 18 (positioned within first open end 17 of housing 5) is sized so as to fully enclose and support positron source 7, and the trailing portion 16 of diffuser housing 18 is substantially cylindrical so as to enclose and support transfer conduit 8 and reaction vessel 9. Leading portion 15 of diffuser housing 18 is conventionally shaped so as to reduce the airspeed, and hence the kinetic energy, of air streaming through first open end 17. Such a leading portion of diffuser housing 18 will effect the transfer of air stream kinetic energy into a nearly equal increase in potential energy in the form of increased air pressure within interior chamber 14. Diffuser housing 18 is formed from the group of metals and composite materials known to those skilled in the art for their structural integrity and durability when subjected to ultra-high velocity fluids (greater than 700 miles per hour) and ultra-high temperatures (greater than 1,000° K), e.g., tungsten, titanium, molybdenum, and their well known alloys.

First open end 17 and second open end 19 are in fluid communication, via interior chamber 14, such that a fluid passageway is defined through housing 5. First open end 17 serves as an inlet port for fluids, such as air, to enter ramjet 1 and second open end 19 serves as an exhaust port. Second open end 19 may be configured as a thrust direction and orifice adjustable nozzle of the type that is familiar to those of ordinary skill in the art.

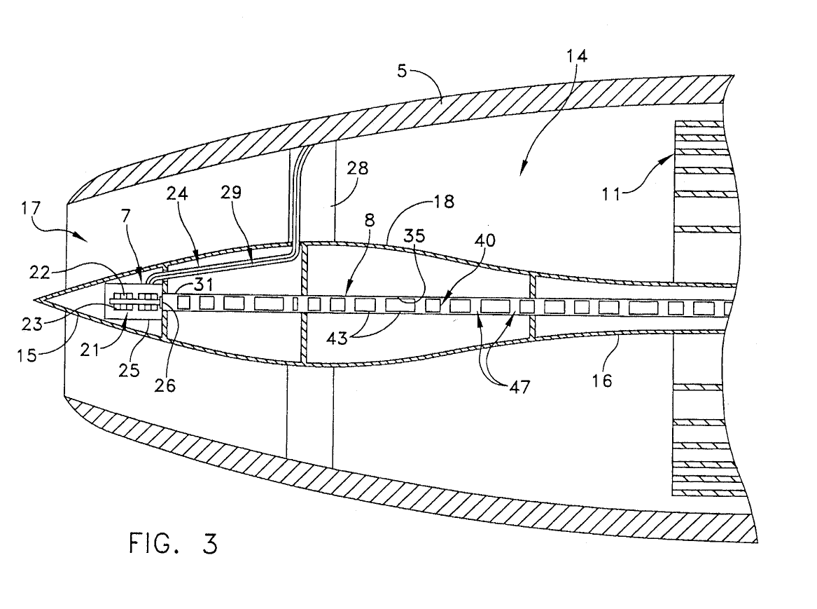

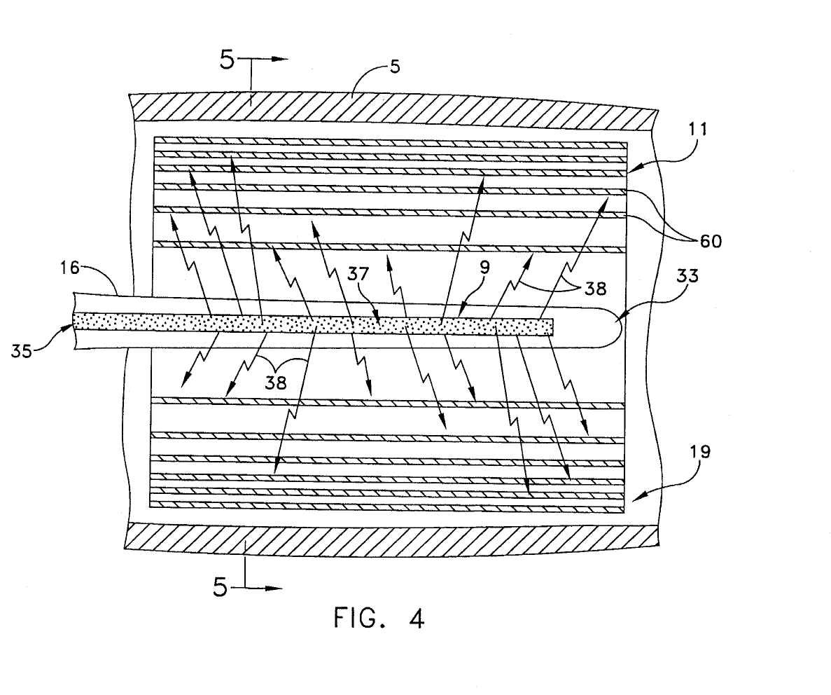

Referring to FIGS. 3 and 4, positron source 7 is positioned within leading portion 15 of diffuser housing 18, and may comprise an antimatter penning trap 21 that is suitable for storing a plurality of positrons, e.g., several hundred micrograms of positrons. Positrons may exist for a time in the form of a positronium atom which is the bound state of an positron and its antiparticle the electron. Positronium atoms may also be stored in positron source 7, and utilized in connection with the present invention. Antimatter penning traps often comprise a highly evacuated, cryostatic magnetic “bottle” of the type well known in the art. For example, U.S. Pat. Nos.: 4,867,939; 4,982,088; 4,990,856; 5,248,883; 5,977,554; and 6,160,263, teach such penning traps and their operation, and are hereby incorporated herein by reference.

For example, penning traps are well known to include a series of coaxially arranged and spaced-apart electrically conductive rings 22 (FIG. 3) that are cooled to about four degrees above absolute zero (minus two hundred and sixty-nine degrees Celsius) during operation. Such temperatures are often achieved through the immersion of the device in liquid helium. Rings 22 are located within a very strong (six Tesla) magnetic field that is directed along the direction of the central axis of the rings, with each ring 22 being interconnected with a source of varying electric potential, via cables or the like 24. Such magnetic fields may be supplied, for example, by the inclusion of magnets 23 formed from super-conducting materials, and cooled with a portion of the liquid helium in which positron source 7 is immersed. Conductive rings 22 are positioned within an enclosure 25 which is evacuated to about 10⁻¹³ torr, and cooled to about four degrees above absolute zero. Appropriate insulation materials (not shown) may be packed around positron source 7 within leading portion 15 of diffuser 18 to aid in the maintenance of the interior of enclosure 25 at cryogenic temperatures. Vacuum and/or cryogenic conduits 29 may also be interconnected to enclosure 25 so as to help regulate the vacuum and temperature levels of penning trap 21.

A static potential is often applied between rings 22 which generates a static potential well along a vertical axis. At the same time, a repulsive potential along a horizontal plane is generated which is overcome by superimposing a static, a very strong (six Tesla) magnetic field along a vertical axis. The horizontal motion of the trapped positrons (or positronium atoms) is a composite of circular cyclotron orbits primarily due to the magnetic field and a circular drift magnetron motion in response to the cross product of the electric field and the magnetic field vectors, i.e., E×B about the vertical axis. The positrons are thus confined in the space defined by the ring electrodes. Penning traps can provide long term confinement of a plurality of positrons or positronium atoms for several days or even weeks.

The positron mass required to be stored in positron source 7 (for a 250 kW power input to ramjet 1, and 10⁴ second, 2.8 hr flight) is determined by the following relationship: N=(2.5×10⁵×10⁴×1)J×1 microgram/180×10⁶ J, or about 13.9 micrograms of positrons supplied from positron source 7.

Alternatively, a specialized “atom-chip” container that utilizes quantum wire and quantum dot technology to store hundreds of micrograms of positronium atoms, may be employed as positron source 7, substantially indefinitely.

Positron source 7 is positioned within leading portion 15 of diffuser 18 so as to be adjacent to first open end 17. A cylindrical container that is about 13 cm in diameter and 100 cm long would provide adequate space for a penning trap 21 or other suitable receptacle of positrons or source of positronium atoms. An exit port 26 is formed on a trailing end of positron source 7 that opens into transfer conduit 8. Suitable structures, e.g., struts, beams, brackets 28, electrical cables 24, and vacuum and cyrogenic conduits 29 are provided for supporting and servicing positron source 7 and the entire structure of diffuser 18. These struts, beams, and brackets 28, electrical cables 24, and vacuum and cryogenic conduits 29 are of the type that are regularly used for supporting, positioning and servicing precision electronic components and cooled systems in aircraft and aircraft engine environments.

Transfer conduit 8 preferably comprises a tube having an open proximal end 31, a closed distal end 33, and an internal passageway 35. Reaction vessel 9 is typically coextensive with transfer conduit 8, and is bounded by closed distal end 33. Transfer conduit 8 extends from positron source 7 into interior chamber 14, with internal passageway 35 being in fluid communication with exit port 26. Positrons or positronium atoms (shown representationally at referenced numeral 37 in FIG. 4) that are discharged into internal passageway 35 from positron source 7 are both confined and urged through transfer conduit 8 by an electrostatic lens assembly 40 within passageway 35.

Electrostatic lens assembly 40 is adapted to be sealingly mounted to positron source 7, via exit port 26, and may take several forms. For example, electrostatic lens assembly 40 may comprise a plurality coaxially aligned, cylindrical tubes 43 that are formed from a highly conductive metal, e.g., copper or its alloys. Tubes 43 are individually interconnected to a source of variable high voltage electrical potential (not shown) in a manner well known to those of ordinary skill in the aircraft design arts. Tubes 43 are sized so as to fit within transfer conduit 8 with gaps 47 defined between predetermined groups of tubes 43 so as to form strong electric field gradients adjacent to the edge portions of the tubes that are positioned on either side of a gap 47.

Electrostatic lens assembly 40 normally does not extend into reaction vessel 9, although it may do so, as needed, for a particular design purpose. Both transfer conduit 8 and reaction vessel 9 are maintained at a similar evacuated state, i.e., internal pressure, as positron source 7. Electrons are generally available within reaction vessel 9 for interaction with, and annihilation of positrons 37 entering reaction vessel 9 from transfer conduit 8. In the case of positronium atoms, an electron will already be paired with a positron so that once the paired structure decays an annihilation will occur. It will be understood that for each positron/electron annihilation that occurs within reaction vessel 9, two 0.511 Mev (million electron-volt) gamma rays will be created which will move away from the locus of annihilation in opposite directions (shown schematically at reference numeral 38 in FIG. 4).

Gamma ray absorption assembly 11 is positioned in substantially surrounding relation to reaction vessel 9, i.e., substantially surrounding relation to trailing portion 16 of diffuser housing 18 which is a locus of positron-electron annihilations. Gamma ray absorption assembly 11 comprises a structure, e.g., material type and/or density (e.g., a graduated radial or longitudinal density) or physical shape, spacing or graded thickness, that provides a predetermined rate of absorption of gamma rays so as to provide for a uniform distributed absorption of the gamma rays throughout the assembly. This uniformly distributed absorption of gamma rays 38 results in a uniform heating across absorption assembly 11. Rate of absorption of gamma rays by absorption assembly 11 means the rate at which gamma rays are captured by the atoms that constitute the structure of the device. This is an intrinsic characteristic of gamma ray absorption assembly 11. Temperatures in the range of from about 2000° K to 3500° K, or more (i.e., temperatures sufficient to sustain ramjet operation at supersonic airspeeds) can be easily achieved, maintained, and controlled in gamma ray absorption assembly 11. Of course, lower or higher temperatures are easily achievable, e.g., in the range from about 1,000° K to about 4500° K, as needed, to obtain efficient ramjet operation in the present invention.

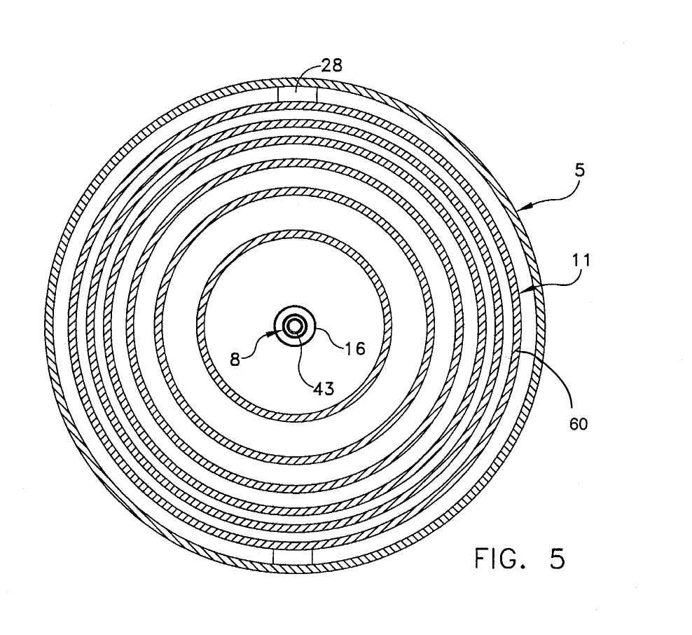

More particularly, a gamma ray absorption assembly 11 formed in accordance with the present invention will exhibit a rate of absorption of 0.511 Mev gamma rays 38 emanating from the positron/electron annihilations occurring in reaction vessel 9, that yields a uniform radial heating of the structure. One example of a gamma ray absorption assembly 11 that has been identified as performing adequately is one or more substantially cylindrical shells 60 assembled so as to be in substantially concentric coaxial relation with one another, with reaction vessel 9 within interior chamber 14 (FIGS. 2-5). Shells 60 may be formed from a suitable metal having a high gamma ray absorption cross-section, e.g., tungsten or its alloys, or a carbon material, such as silicon carbide or its equivalents.

Although a single shell comprising a radially graded density, i.e. a density that increases with radial distance from a source of gamma rays 38 will function according to the invention, a plurality of concentric shells 60 of varying thickness and radial distance from reaction vessel 9 are often employed since this arrangement improves the fluid flow characteristics within ramjet 1. Additionally, plurality of concentric shells 60 may be coated with an appropriate material, e.g., boron nitride, to help ameliorate tungsten oxidation and burning at low temperatures. Each of concentric shells 60 may be constructed and arranged so as to be at differing radial offsets from reaction vessel 9, and are supported by struts, beams, brackets 28, as needed for structural integrity. Also, each individual shell 60 may have one or more different structural or material characteristics as compared to other ones of shells 60, e.g., thinner or thicker, round leading or trailing edges, more or less dense, coated or uncoated, etc.

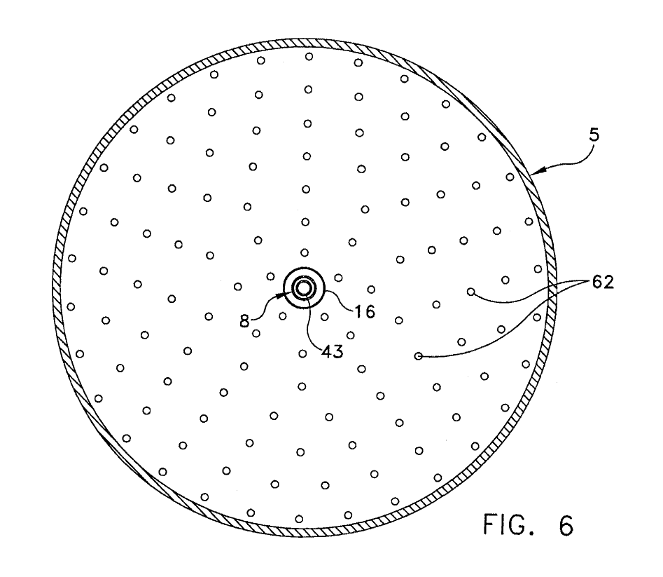

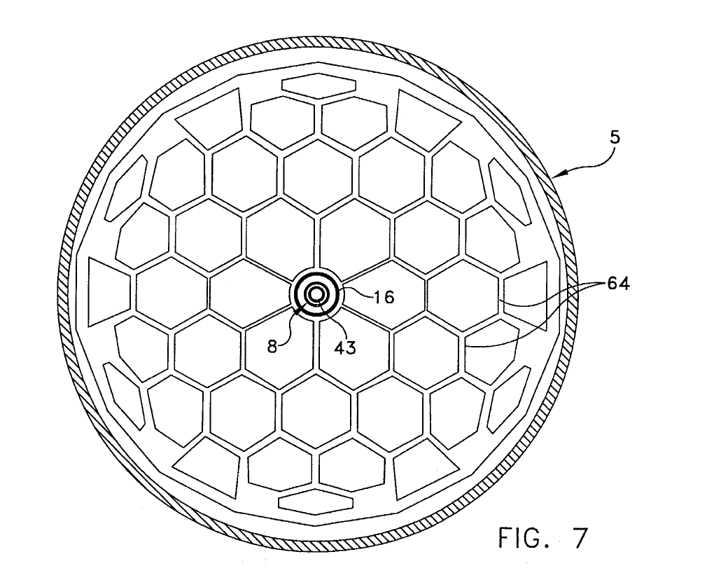

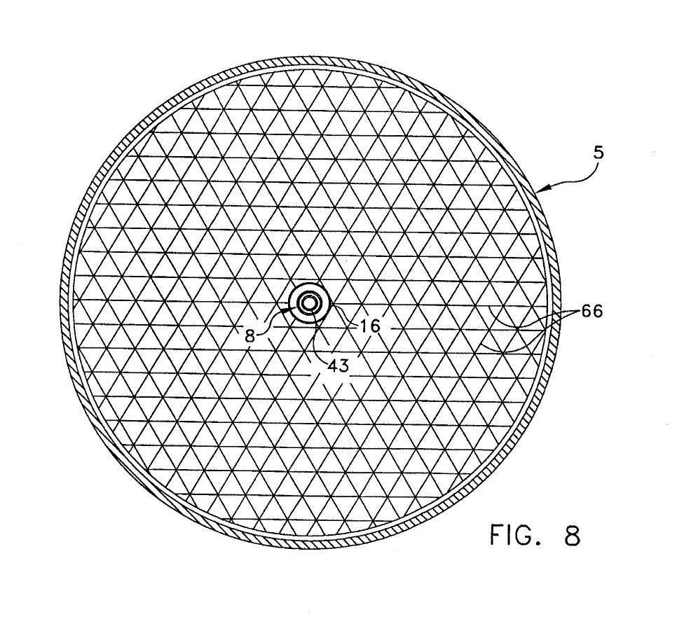

Many other structures may also be used in connection with gamma ray absorption assembly 11 (FIGS. 6-8). By way of example only, and not limitation, an assembly of one or more rods 62, honeycomb 64, mesh 66, tubes (hollow rods) as well as other fluid flow compatible, aerodynamically shaped solid or porous bodies, or combinations thereof will work adequately with ramjet 1, as long as each of these alternatives are arranged and selected so that the resulting “convection chamber” structure provides a maximized gamma ray absorption gradient yielding a uniform heating of the structure.

Ramjet 1 operates by first causing a high velocity (normally supersonic) air stream to enter first open end 17 of housing 5 where leading portion 15 of diffuser housing 18 acts to reduce the air speed and hence kinetic energy of the air as it passes through open end 17. The acceleration to supersonic airspeeds is normally accomplished by conventional, chemically fueled engines that are attached to vehicle 20. At supersonic speeds, a shock compression of the air flow will occur depending upon the free stream Mach number. The location of this shock will vary. To avoid the shock from entering convection chamber 11, leading end 15 of diffuser 18 may be movable, forwardly or rearwardly relative to housing 5, by the inclusion of electromechanical drive means of the type known in the art. The reduction in kinetic energy of the air stream entering first open end 17, via diffuser 18, results in a nearly equal increase in potential energy of the air stream in the form of an increased air pressure within interior chamber 14.

This higher-pressure air enters gamma ray absorption assembly 11 where it is superheated through conductive heat transfer from, e.g., shells 60, rods 62, honeycomb 64, or mesh 66, thereby significantly increasing the gas pressure within housing 5, i.e., significantly adding to the potential energy stored in the air stream passing through ramjet 1. It will be understood that gamma ray absorption assembly 11 provides a convective heat transfer function within ramjet 1 that is directly analogous to the function of a conventional combustion chamber positioned within a prior art ramjet, and adapted for the burning of chemical fuels. In particular, gamma ray absorption assembly 11, e.g., shells 60, rods 62, honeycomb 64, or mesh 66, will be uniformly heated to approximately 3,000° K by the absorption of 0.511 Mev gamma rays resulting from the continuous annihilation of positrons and electrons within reaction vessel 9. Thus gamma ray absorption assembly 11 is generally referred to as a “convection chamber”, whether or not it takes a structural form that includes a compartment or void space defined within interior chamber 14.

As the compressed stream of gas passes over the gamma ray absorption assembly, it will be superheated through conductive contact with the surfaces of the heated material. The superheated gas is ejected rearwardly, from second open end 19 of housing 5, thereby converting the potential energy stored in the air stream to kinetic energy in the form of an exhaust of gas traveling at a velocity that is significantly greater than the flight speed of vehicle 20 to which ramjet 1 is assembled. The efficiency of ramjet 1 in converting the energy stored within gamma ray absorption assembly 11 into kinetic energy of the air stream leaving second open end 19 depends upon the ratio of the pressure in interior chamber 14 to the ambient air pressure surrounding ramjet 1. This pressure ratio, in turn, depends upon the flight speed of vehicle 20, or, more exactly, upon the flight Mach number.

It is to be understood that the present invention is by no means limited only to the particular constructions herein disclosed and shown in the drawings, but also comprises any modifications or equivalents within the scope of the claims.

What is claimed is:

1. A convection chamber for a ramjet comprising a rate of absorption of gamma rays that yields a uniform heating of said convection chamber to a temperature sufficient to sustain ramjet operation.

2. A convection chamber according to claim 1 wherein said convection chamber substantially surrounds a locus of positron-electron annihilations.

3. A convection chamber according to claim 1 comprising a structure that provides a predetermined rate of absorption of gamma rays so as to provide for a uniform distributed absorption of said gamma rays.

4. A convection chamber according to claim 1 comprising a graduated density so as to provide a predetermined rate of absorption of gamma rays.

5. A convection chamber according to claim 1 comprising a graded thickness so as to provide a predetermined rate of absorption of gamma rays.

6. A convection chamber according to claim 1 comprising a boron nitride coating.

7. A convection chamber according to claim 1 comprising tungsten.

8. A convection chamber for a ramjet comprising at least one open ended cylinder that provides a rate of absorption of gamma rays that yields a uniform heating of said at least one cylinder to a temperature sufficient to sustain ramjet operation.

9. A convection chamber according to claim 8 comprising a plurality of concentrically arranged cylinders.

10. A convection chamber according to claim 9 wherein each of said concentric cylinders are arranged so as to be at differing radial offsets from a locus of positron-electron annihilations.

11. A convection chamber according to claim 9 comprising a boron nitride coating.

12. A convection chamber according to claim 9 comprising tungsten.

13. A convection chamber for a ramjet comprising a plurality of rods that provide a rate of absorption of gamma rays that yields a uniform heating of said plurality of rods to a temperature sufficient to sustain ramjet operation.

14. A convection chamber for a ramjet comprising a honeycomb structure that provide a rate of absorption of gamma rays that yields a uniform heating of said honeycomb structure to a temperature sufficient to sustain ramjet operation.

15. A convection chamber for a ramjet comprising means for absorbing gamma rays so as to yield a uniform heating of said absorbing means to a temperature sufficient to sustain ramjet operation.

16. A convection chamber according to claim 15 wherein said means for absorbing gamma rays comprises a fluid flow compatible, aerodynamically shaped body.

17. A convection chamber according to claim 15 wherein said means for absorbing gamma rays comprises a mesh.

18. A convection chamber according to claim 15 wherein said means for absorbing gamma rays comprises a plurality of hollow rods.

19. A ramjet powered by gamma rays resulting from positron/electron annihilations comprising:
a housing having a first open end, a second open end, and defining an interior chamber in fluid communication with said first open end and said second open end so as to form a fluid passageway;
a source of positrons;
a reaction vessel that is positioned within said interior chamber and arranged in flow communication with said source of positrons so as to provide a flow of positrons into said reaction vessel; and
a gamma ray absorption assembly positioned within said fluid passageway and adjacent to said reaction vessel.

20. A ramjet according to claim 19 wherein said gamma ray absorption assembly comprises a rate of absorption of gamma rays that yields a uniform heating of said assembly to a temperature sufficient to sustain ramjet operation.

21. A ramjet according to claim 19 wherein said gamma ray absorption assembly comprises at least one open ended cylinder that provides a rate of absorption of gamma rays that yields a uniform heating of said at least one cylinder to a temperature sufficient to sustain ramjet operation.

22. A ramjet according to claim 19 wherein said gamma ray absorption assembly comprises a plurality of concentrically arranged cylinders.

23. A ramjet according to claim 19 wherein said gamma ray absorption assembly comprises a plurality of rods that provide a rate of absorption of gamma rays that yields a uniform heating of said plurality of rods to a temperature sufficient to sustain ramjet operation.

24. A ramjet according to claim 19 wherein said gamma ray absorption assembly comprises a honeycomb structure that provide a rate of absorption of gamma rays that yields a uniform heating of said honeycomb structure to a temperature sufficient to sustain ramjet operation.

25. A ramjet according to claim 19 wherein said gamma ray absorption assembly comprises means for absorbing gamma rays so as to yield a uniform heating of said absorbing means to a temperature sufficient to sustain ramjet operation.

26. A ramjet according to claim 19 wherein said positron source is positioned within said housing.

27. A ramjet according to claim 19 wherein said positron source comprises a penning trap.

28. A ramjet according to claim 19 wherein said positron source is arranged in flow communication with said reaction vessel through a transfer conduit.

29. A ramjet according to claim 28 wherein said transfer conduit comprises a tube having an open proximal end, a closed distal end, and an internal passageway which is coextensive with said reaction vessel.

30. A ramjet according to claim 29 wherein a plurality of at least one of positrons and positronium atoms are discharged into said internal passageway from said positron source and are confined and urged through said transfer conduit by an electrostatic lens assembly positioned within said internal passageway.

31. A ramjet according to claim 30 wherein said electrostatic lens assembly comprises a plurality coaxially aligned conductive tubes that are interconnected to a source of high voltage electrical potential so as to form strong electric field gradients adjacent to edge portions of said tubes.

32. A ramjet according to claim 28 wherein said transfer conduit and said reaction vessel are maintained at an internal pressure substantially the same as an internal pressure of said positron source.

33. A method of heating a convection chamber of a ramjet engine comprising:
annihilating a plurality of positrons with an equal plurality of electrons so as to produce an emission of gamma rays; and
absorbing said gamma rays in a convection chamber of said ramjet engine wherein said convection chamber comprises a rate of absorption of gamma rays that yields a uniform heating of said convection chamber to a temperature sufficient to sustain ramjet operation.

34. A method of providing a fuel source to a ramjet engine comprising:
urging a plurality of positrons into close interactions with an equal plurality of electrons so as to produce a plurality of gamma ray emissions; and
absorbing said gamma rays in a convection chamber of said ramjet engine wherein said convection chamber comprises a rate of absorption of gamma rays that yields a uniform heating of said convection chamber to a temperature sufficient to sustain ramjet operation.
